(19) United States
(12) Patent Application Publication
(10) Pub. No.: US 2002/0074937 A1
(43) Pub. Date: Jun. 20, 2002

(54) Flexible material for electrooptic displays

(76) Inventors: Felix Guberman, Beer Sheva (IL); Irina Kiryushev, Ramat Gan (IL)

Correspondence Address: BROWDY AND NEIMARK, P.L.L.C., 624 NINTH STREET, NW, SUITE 300, WASHINGTON, DC, 20001-5303, US

(21) Appl. No.: 09/846,684

(22) Filed: May 2, 2001

Related U.S. Application Data
(60) Provisional application No. 60/255,888, filed on Dec. 18, 2000.

(51) Int. Cl. H01J 1/62

(52) U.S. Cl. 313/511

(57) ABSTRACT

A flexible electrooptic display material comprising two sets of elongated elements. The first set elements are tape yarns comprising a layer of electrooptically active (EOA) substance, one or more transparent conductive layers disposed on one side of the EOA layer, and a transparent carrying layer. The elements of the second set comprise at least a conductive layer. The two sets form a matrix display structure in which the elements of each set are in contact with the elements of the other set. Single display elements (pixels) are formed in the overlapping regions between the elements where the EOA substance is disposed between a conductive layer of a first set yarn and a conductive layer of a second set element. The two sets of elements are preferably interlocked in woven arrangement, and preferably two sets of tape yarns having the same structure are used.

### FIELD OF THE INVENTION

This invention relates to flexible electro-optic displays, in particular to displays woven from flat yarns.

### BACKGROUND OF THE INVENTION

An electro-optic display is a device designed to change its optical behavior in response to an applied electric or magnetic field or flux. Such a display usually comprises a plurality of display elements or pixels including an electro-optically active substance, organized in a matrix or other pattern. Each display element can be controlled to change its optical behavior independently, thereby forming an image perceptible by a viewer. The change of the optical behavior depends on the electro-optically active substance used in the display and may be a change of color, density, transparency, light emitting, light reflection, etc.

Flexible displays are known to be made on the basis of flexible polymer films, in particular light emitting polymers (LEP), as for example disclosed in U.S. Pat. No. 5,399,502. The display material includes a semiconductor LEP layer laminated with two conductive layers. The layers are formed by evaporation, sputtering, and other techniques, which pose principle limitations to the display size. The pattern of control electrodes is formed in said two conductive layers by lithography which also limits the device size.

The limitations of size are largely overcome in flexible displays made of two sets of fibers arranged in a two-dimensional array, as disclosed, for example, in U.S. Pat. Nos. 5,962,967 and 6,072,619. Each fiber includes a longitudinal conductor, and the fibers of at least one set are coated with light-emitting or other active electro-optic substance. A display element (pixel) is formed at each intersection of a fiber of one set with a fiber of the other set. The two-dimensional array may be formed by overlapping fibers of one set with the fibers of the other set, but preferably the two sets of fibers are interlocked in a woven arrangement. Fibers may have round or flat cross-section. The manufacture process of fibers does not pose limitations to the length and, using known weaving techniques, flexible displays of large sizes may be produced. Woven displays do not need patterning (printing) of electrodes or electrooptically active substance since, the matrix structure with quite uniform pixel spacing is inherent in the nature of the textile fabric. Woven displays are also more flexible and robust than integral film displays.

A woven display produced from flat fibers or strips in basket weave is also described in WO99/19858, where the display comprises two intersecting sets of stripes. One of these sets may consist entirely of display stripes while the other set consists entirely of conductive stripes, or both sets may comprise display stripes and conductive stripes. The display stripes have a back conductive layer, an intermediate electroluminescent layer, and a front transparent conductive layer. Display elements are formed at junctions where a conductive stripe contacts the back conductive layer of a display stripe.

### SUMMARY OF THE INVENTION

In accordance with one aspect of the present invention, there is provided a flexible electrooptic display material comprising a first and a second set of elongated elements. The elements of at least the first set are tape yarns comprising a layer of electrooptically active (EOA) substance capable of reversibly changing its optical properties or of emitting light when subjected to electric or magnetic field, one or more transparent or translucent conductive layers disposed on one side of the EOA layer, and a transparent or translucent carrying layer. The elements of the second set comprise at least a conductive layer or wire. The two sets build a matrix display structure in which the elements of each set are transverse to, overlapping and in contact with the elements of the other set. Single display elements (pixels) are formed in those overlapping regions between the elements where the EOA substance is disposed between a conductive layer of a first set yarn and a conductive layer or wire of a second set element. The two sets of elements are preferably interlocked in woven arrangement, and preferably two sets of tape yarns having the same structure are used.

In accordance with an other aspect of the present invention, there is provided a multi-layered tape yarn especially suitable for weaving flexible electrooptic displays, comprising a layer of electrooptically active (EOA) substance, one or more transparent or translucent conductive layers, and a transparent or translucent carrying layer, wherein said EOA layer is disposed at one side of the conductive layers. The layers in the tape yarn are preferably disposed in the following order: (a) conductive layer, a carrying layer, and a layer of EOA substance; (b) a carrying layer, a conductive layer, and a layer of EOA substance, or (c) a first conductive layer, a carrying layer, a second conductive layer, and a layer of EOA substance. A conductive layer or an EOA layer may be designed to perform a carrying function, in which case there might be no separate carrying layer.

Conductive layers preferably incorporate at least one highly conductive band of total width substantially less than the width of the conductive layer.

The display material of the present invention has good flexibility, foldability, and mechanical stability. The structure may involve only one kind of tape yarn or two very similar tape yarns which makes the display more durable upon folding and rolling. In comparison with display materials woven entirely from round fibers, the flat yarn material yields pixels with large optically active area which is not obscured by wires. The inclusion of a highly conductive strip drastically reduces the electrode resistance without noticeable impairing of the brightness or visibility. Tape yarns of the present invention can be readily and effectively manufactured by well known and developed methods, and the material can be woven on conventional machines. There is no inherent limitation to the dimensions of a woven flexible display made from the textile material of the present invention.

### BRIEF DESCRIPTION OF THE DRAWINGS

In order to understand the invention and to see how it may be carried out in practice, a number of embodiments will now be described, by way of non-limiting example only, with reference to the accompanying drawings, in which:

FIGS. 1A, 1B and 1C show sectional structures of a flat tape yarn in accordance with one aspect of the present invention.

FIG. 2 shows a general woven structure of a flexible display in accordance with the present invention;

FIG. 3 illustrates the operation of a flexible display material in accordance with one embodiment of the present invention.

FIG. 4 illustrates the operation of a flexible display material in accordance with another embodiment of the present invention.

FIG. 5 illustrates the operation of a flexible display material in accordance with a further embodiment of the present invention.

### DETAILED DESCRIPTION OF THE INVENTION

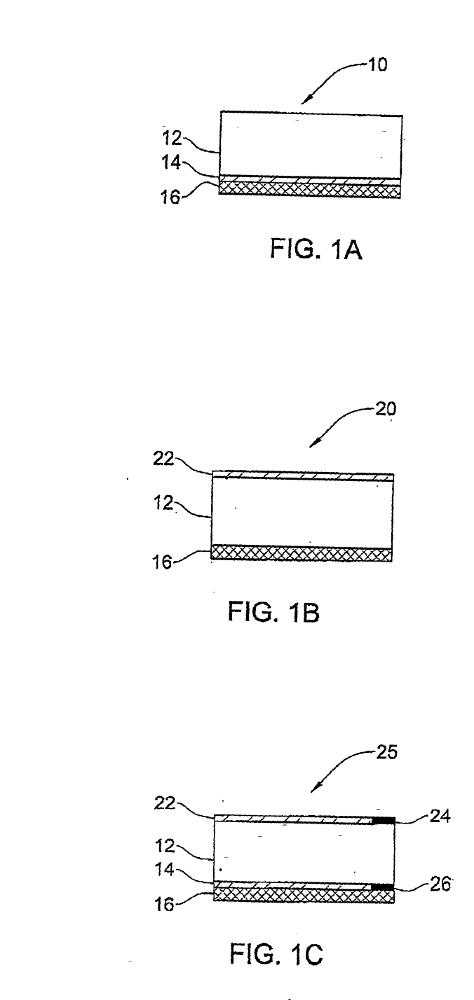

In accordance with the present invention there are provided multi-layer structures of tape yarns for a flexible display and woven material for flexible display based on such yarn. As shown in FIG. 1A, a tape yarn 10 for a flexible display comprises the following layers, starting from the side of the viewer: a transparent or translucent carrying layer 12, a transparent or translucent intermediate conductive layer 14, and a layer of electrooptically active (EOA) substance 16. The carrying layer 12 is a dielectric, preferably of high polar stiff polymer material such as polyamide (PA), polyvinylidene fluoride (PVDF), polyvinyl chloride (PVC), etc., for example, 10-50 μm thick and may be laid in a few layers. The conductive layer 14 may be of indium-tin oxide (ITO), tin oxide, zinc oxide, etc. or/and conductive polymers, preferably 0.01-5.0 μm thick. The EOA substance 16 is capable of reversibly changing its optical properties such as transparency, color, reflectivity, etc. or of emitting light when subjected to electric or magnetic field. This may be, for example, electroluminescent (EL) system such as inorganic EL-powder, thin-film inorganic EL, EL-polymer, EL-organic or liquid crystal system, in a layer 1-150 μm thick. Preferably, a bond-promoting transparent layer of thermoplastic lacquer 2-30 μm thick is laid over the tape yarn (not shown in FIG. 1A) to provide for bonding the yarns together after the overlapping.

A similar tape yarn 20 is shown in FIG. 1B but here there is a front conductive layer 22 laid over the carrying layer 12.

The tape yarn may comprise also other layers, depending on the nature of the active substance 16 and the mode of operation of the yarn in the woven material. For example, as seen in FIG. 1C, there may be two transparent conductive layers: a layer 22 in front of the carrying layer 12, and an intermediate layer 14 between the carrying layer 12 and the EOA layer 16. In this case the carrying layer 12 may be of transparent dielectric material 10-500 μm thick, for example stiff polymer films such as polyamide, polyvinylidene fluoride, polyvinyl chloride, polyethylene, polypropylene, polyester, since the carrying layer does not fall between electrodes of a display pixel (see FIG. 5).

As illustrated in FIG. 1C, a multi-layer tape yarn 25 for a flexible display may have additional conductive strips 24 or 26 of highly conductive material such as aluminum or other metal, in contact with the transparent conductive layer 14 or 22. It is understood that these conductive strips need not be transparent but should be of substantially smaller width than the optically active layer 16, preferably less than 10% of the latter. Such strips may drastically reduce the electric resistance of the conductive layers and enhance the efficiency of the display.

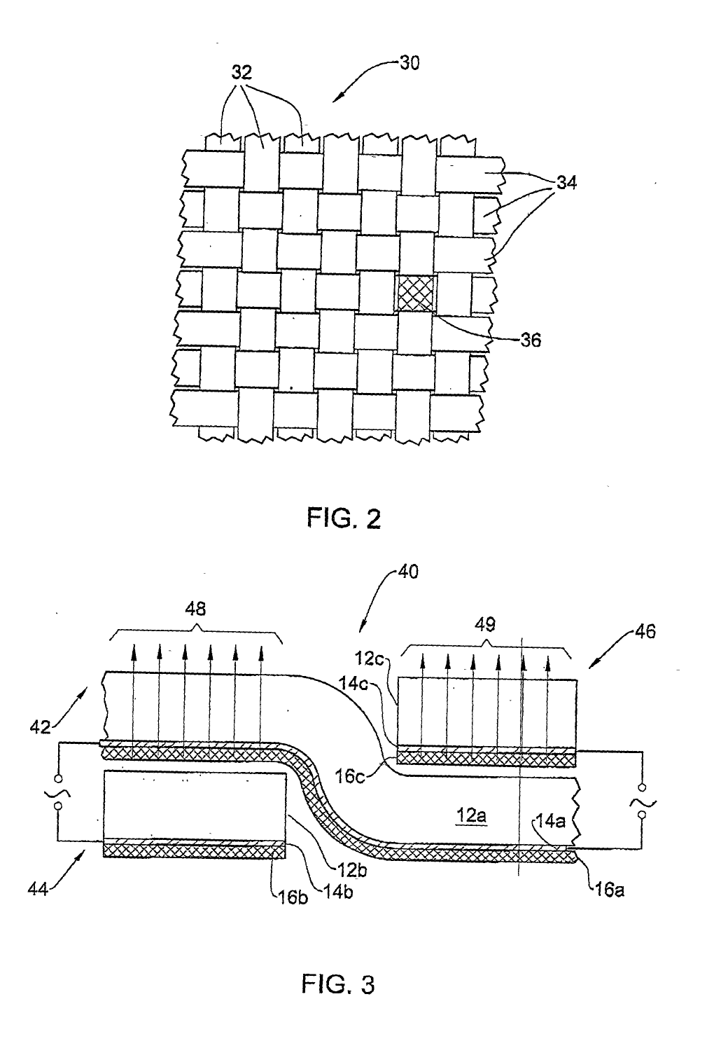

The structure of the flexible display material based on the above described tape yarns is shown in FIG. 2. It is a textile web 30 of simple but robust and stable basket weave, consisting of a set of warp yarns 32 and a transverse set of weft yarns 34. Each set of yarns preferably comprises identical yarns with multi-layer structure as shown and explained with reference to FIGS. 1A to 1C. In the regions where a warp yarn 32 overlaps a weft yarn 34, the yarns are in contact and form a display element (pixel) 36. In the display element 36, the EOA substance in the layer 16 is capable of reversibly changing its transparency, color, reflectivity, etc. or of emitting light when a suitable electric voltage is applied to predetermined conductive layers of the corresponding warp and weft yarns, as will be explained in the embodiments below. It is understandable, though not shown, that a woven or non-woven flexible display material may be obtained by providing one set of yarns of the shown structure and an overlapping transverse set of any conductive yarns or wires.

The operation of the flexible display material in accordance with the present invention is illustrated by three exemplary embodiments of electroluminescent (EL) display material. It should be understood that a different kind of electro-optically active substance may be used with the same structures of the material.

On FIG. 3, it is shown a sectional view of a flexible textile display material 40 woven from warp yarns 42 and weft yarns 44 and 46. The yarns have the multi-layered structure shown in FIG. 1A, with front transparent carrier layer 12a, 12b, 12c, transparent intermediate conductive layer 14a, 14b, 14c, and EL layer 16a, 16b, 16c, in yarns 42, 44, 46, respectively. Two kinds of display elements are formed between the warp and the weft yarns: display element 48 with the warp yarn 42 in front of the weft yarn 46, and display element 49 with the weft yarn 46 in front of the warp yarn 42. It should be understood that the warp and the weft yarns are in tight contact and the gap therebetween in FIGS. 3, 4 and 5 is shown for clarity only.

Both kinds of display elements have identical operation and functional structure. In the element 48, electric voltage is applied to the transparent conductive layers 14a and 14b, hereby making the EL layer 16a therebetween to emit light. In the element 49, electric voltage is applied to the transparent conductive layers 14a and 14c, thereby making the EL layer 16c therebetween to emit light. It will be appreciated that the EL layer 16b is not in operating state in the display element 48 but becomes a part of an operating pixel in display elements which are farther to the front or to the back of the section plane shown in FIG. 3.

The display elements 48 and 49 in the structure shown in FIG. 3 also include, between the electrodes, a portion of the transparent carrying layer 12b and 12a respectively. That is why, the carrying layer 12 is preferably made of high permittivity film, such as polyamide film.

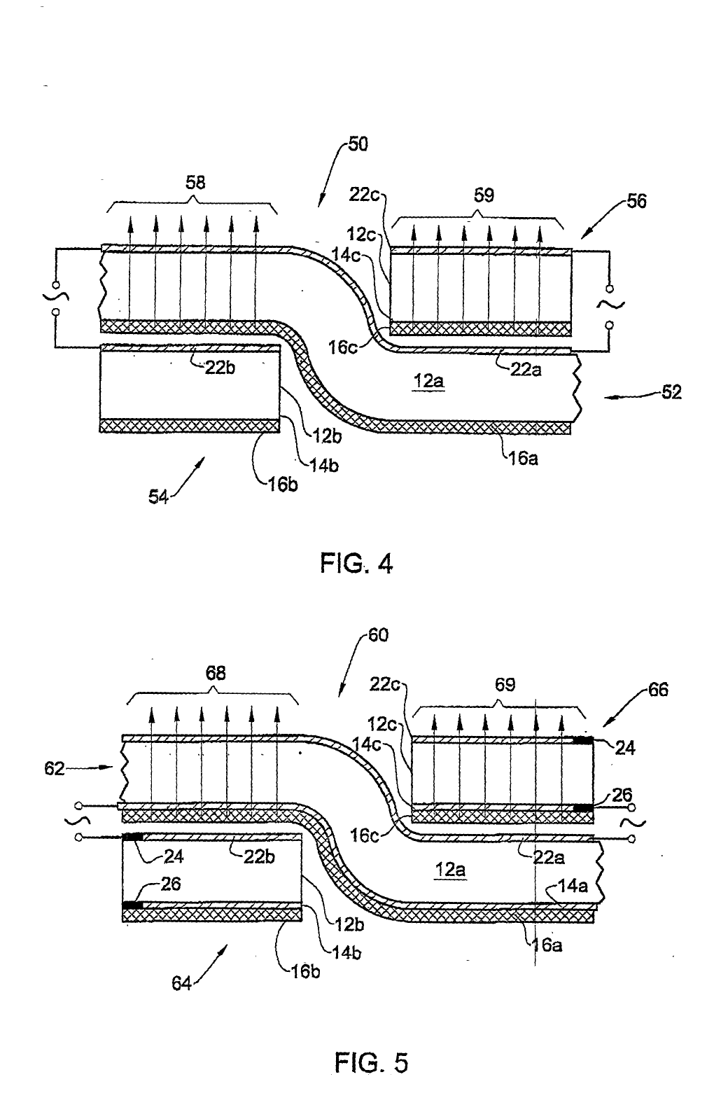

On FIG. 4, it is shown a sectional view of a flexible textile display material 50 woven from warp yarns 52 and weft yarns 54 and 56. The yarns have the multi-layered structure shown in FIG. 1B, and therefore the structure of the material 50 differs from the structure of FIG. 3 in that the transparent conductive layer 22a, 22b, 22c is in frontal position. A portion of the transparent carrying layer 12a and 12c is included in display elements 58 and 59.

On FIG. 5, it is shown a sectional view of a flexible textile display material 60 woven from warp yarns 62 and weft yarns 64 and 66. The yarns, have the multi-layered structure shown in. FIG. 1C, comprising intermediate conductive layer 14a, 14b, 14c and a front transparent conductive layer 22a, 22b, 22c, in yarns 62, 64, 66, respectively. Two kinds of display elements with identical operation and functional structure are formed between warp and weft yarns: display element 68 with the warp yarn 62 in front of the weft yarn 66, and display element 69 with the weft yarn 66 in front of the warp yarn 62. However, in this case the electric voltage is applied to the light emitting EL layer 16 through conductive layers 14 and 22 and the carrying layer 12 is not within the display element. Thus, the carrying layer 12 may be made also of such polymer as polyester. The warp and weft yarns may have highly conductive bands 24 and 26, as shown above in FIG. 1C.

The manufacture of flexible display textile involves technological operations well known in the practice, for example:

manufacture of carrier polymer film in master rolls;

coating one or both sides of the carrier film with a conductive layer of transparent material;

coating the conductive layers with aluminum strips by lithographic technique;

lacquering the back side of the film with electroluminescent lacquer;

bond promoting lacquering onto the opposite side;

slitting the master roll into narrow tape yarns;

weaving of the display material on conventional textile machines;

bonding together the strips by pressing;

encapsulation in polymer by extrusion coating or lamination.

Although a description of specific embodiments has been presented, it is contemplated that various changes could be made without deviating from the scope of the present invention. For example, the tape yarn of the present invention may include additional layers such as insulation, or the display material may be encapsulated or fixed to various substrates after the matrix structure is formed.

1. Electrooptic display material comprising a first and a second set of elongated elements, at least the elements of said first set being tape yarns, each yarn comprising a layer of electrooptically active (EOA) substance capable of reversibly changing its optical properties or of emitting light when subjected to electric or magnetic field, one or more transparent or translucent conductive layers disposed on one side of said EOA layer, and a transparent or translucent carrying layer, each element of said second set comprising at least a conductive layer or wire, said two sets building a matrix display structure in which the elements of each set are transverse to and overlapping the elements of the other set, wherein single display elements (pixels) are formed in those overlapping regions between said elements where said EOA substance is disposed between a conductive layer of a first set element and a conductive layer or wire of a second set element.

2. A display material according to claim 1, wherein the elements of said two sets are interlocked in woven arrangement.

3. A display material according to claim 2, wherein the elements of said second set are tape yarns with the same structure as the tape yarns of said first set.

4. A display material according to claim 1, wherein said carrying layer is disposed between said conductive layer and said layer of EOA substance.

5. A display material according to claim 1, wherein said conductive layer is disposed between said carrying layer and said layer of EOA substance.

6. A display material according to claim 1, further comprising a second conductive layer, the two conductive layers being disposed on both sides of said carrying layer.

7. A display material according to claim 1, wherein at least one of said transparent or translucent conductive layers incorporates at least one highly conductive band of total width substantially less than the width of said conductive layer.

8. A multi-layered tape yarn especially suitable for weaving flexible electrooptic displays, comprising a layer of electrooptically active (EOA) substance capable of reversibly changing its optical properties or of emitting light when subjected to electric or magnetic field, one or more transparent or translucent conductive layers, and a transparent or translucent carrying layer, wherein said EOA layer is disposed on one side of said conductive layers.

9. A multi-layered tape yarn according to claim 8, wherein said carrying layer is disposed between said conductive layer and said layer of EOA substance.

10. A multi-layered tape yarn according to claim 8, wherein said conductive layer is disposed between said carrying layer and said layer of EOA substance.

11. A multi-layered tape yarn according to claim 8, further comprising a second conductive layer, the two conductive layers being disposed on both sides of said carrying layer.

12. A multi-layered tape yarn according to claim 8, wherein said conductive layer incorporates at least one highly conductive strip of total width substantially less than the width of said conductive layer.
